(19) United States
(12) Patent Application Publication
(10) Pub. No.: US 2024/0127167 A1
(43) Pub. Date: Apr. 18, 2024

(54) METHOD AND ELECTRONIC APPARATUS FOR PREDICTIVE VALUE DECISION AND COMPUTER-READABLE RECORDING MEDIUM THEREOF

(71) Applicant: Wistron Corporation, New Taipei City (TW)

(72) Inventors: Ting-Ru Yang, New Taipei City (TW); Yi-Shiuan Chen, New Taipei City (TW)

(73) Assignee: Wistron Corporation, New Taipei City (TW)

(21) Appl. No.: 18/077,182

(22) Filed: Dec. 7, 2022

(30) Foreign Application Priority Data
Oct. 12, 2022 (TW) 111138712

(51) Int. Cl. G06Q 10/083; G06Q 10/04

(52) U.S. Cl. CPC G06Q 10/0838; G06Q 10/04

(57) ABSTRACT

A method and an electronic apparatus for predictive value decision and a computer-readable recording medium thereof are provided. First, a model operation interface is activated, and in response to receiving an operation through the model operation interface, the following steps are executed. A shipment predictive value at a target time point is calculated based on historical shipment data. Next, a change ratio scale corresponding to the target time point is calculated using the shipment predictive value corresponding to the target time point and multiple previous shipment predictive values at multiple time points before the target time point. Moreover, an average value of past change ratio scales corresponding to the target time point is calculated based on the historical shipment data. Finally, predictive performance information is provided based on the average value of the past change ratio scales and the change ratio scale corresponding to the target time point.

### CROSS-REFERENCE TO RELATED APPLICATION

This application claims the priority benefit of Taiwan application serial no. 111138712, filed on Oct. 12, 2022. The entirety of the above-mentioned patent application is hereby incorporated by reference herein and made a part of this specification.

### BACKGROUND

### Technical Field

The disclosure relates to a computer computing mechanism, and more particularly to a method and an electronic apparatus for predictive value decision and a computer-readable recording medium thereof.

### Description of Related Art

After products are produced, the business unit first ships the products to each warehouse for storage based on experience of personnel and according to orders of customers, and deliver the products together at the end of the month. In order to ensure that the shipment volume at the end of the month can meet the requirements of the customers, the business unit determines the shipment standard volume at the end of the month according to the inventory quantity, available resources of manpower and materials, and production plan, and calculates the daily average standard shipment volume for real-time monitoring of the efficiency of product production quantity. However, the current method for estimating the shipment standard volume at the end of the month does not have a scientific measurement and monitoring mechanism, and the accuracy of the shipment standard volume cannot be confirmed until the end of the month, which is not conducive to controlling the purchase quantity of raw materials in advance, maximizing the manufacturing capacity of the factory, and real-time monitoring of the progress of completion of the shipment target. At the same time, it is necessary to maintain a relatively high inventory quantity to reduce the risk of losing sales opportunities, which causes increased inventory costs and reduced inventory turnover efficiency and profitability.

### SUMMARY

The disclosure provides a method and an electronic apparatus for predictive value decision and a computer-readable recording medium thereof, which can improve reliability of a predictive value.

The method for predictive value decision of the disclosure is executed using a processor. The method includes activating a model operation interface, and in response to receiving an operation through the model operation interface, executing the following steps. A shipment predictive value at a target time point is calculated based on historical shipment data. A change ratio scale corresponding to the target time point is calculated based on the shipment predictive value corresponding to the target time point and multiple previous shipment predictive values at multiple time points before the target time point. An average value of past change ratio scales corresponding to the target time point is calculated based on a historical change ratio scale. Predictive performance information is provided based on the average value of the past change ratio scales and the change ratio scale corresponding to the target time point.

In an embodiment of the disclosure, the step of calculating the shipment predictive value at the target time point based on the historical shipment data includes taking an actual cumulative shipment volume at T past time points included within a current time interval up to the target time point from the historical shipment data to calculate the shipment predictive value at the target time point. The shipment predictive value at the target time point=(the actual cumulative shipment volume÷T)×D, where D is a total number of time points within the current time interval.

In an embodiment of the disclosure, the step of calculating the shipment predictive value at the target time point based on the historical shipment data includes taking a first actual cumulative shipment volume at m1 past time points included within a past time interval from the historical shipment data; taking a second actual cumulative shipment volume at m2 time points included within a current time interval up to the target time point from the historical shipment data; and calculate the shipment predictive value at the target time point based on the first actual cumulative shipment volume and the second actual cumulative shipment volume. The shipment predictive value at the target time point=[(the first actual cumulative shipment volume+the second actual cumulative shipment volume)÷(m1+m2)]×(m1+D)−the first actual cumulative shipment volume, where D is a total number of time points within the current time interval.

In an embodiment of the disclosure, the step of calculating the shipment predictive value at the target time point based on the historical shipment data includes taking an actual cumulative shipment volume at T past time points included within a current time interval up to the target time point from the historical shipment data; estimating a shipment proportion based on the historical shipment data; and calculating the shipment predictive value at the target time point based on the actual cumulative shipment volume and the shipment proportion.

In an embodiment of the disclosure, the step of calculating the change ratio scale corresponding to the target time point includes calculating a weighted average value at the target time point based on a weight value, the shipment predictive value at the target time point, and a weighted average value at a time point before the target time point, wherein the target time point is one of an (n+1)th time point to a last time point within a current time interval, and a weighted average value at an nth time point within the current time interval is an average value of n shipment predictive values from a 1st time point to the nth time point; calculating a weighted standard deviation at the target time point based on the weight value, and the shipment predictive values and the weighted average values at the target time point and previous time points; and calculating the change ratio scale based on the weighted average value and the shipment predictive value corresponding to the target time point. The change ratio scale=(the weighted standard deviation×a specified magnification)−the shipment predictive value, where the specified magnification≥1.

In an embodiment of the disclosure, the method for predictive value decision further includes adding a fixed ratio scale to the shipment predictive value at the target time point as an upper limit value of a predictive shipment range, and subtracting the fixed ratio scale from the shipment predictive value at the target time point as a lower limit value of the predictive shipment range.

In an embodiment of the disclosure, the method for predictive value decision further includes calculating a miss rate at each time point of the current time interval based on actual shipment data of a plurality of past time intervals included in the historical shipment data and the predictive shipment range at each time point within a current time interval; calculating multiple past change ratio scales at multiple past time points included in each of the past time intervals based on a shipment predictive value of each of the past time intervals, wherein all time points within the current time interval and all past time points within each of the past time intervals are set based on a time unit; calculating the average value of the past change ratio scales corresponding to the each time unit based on the past change ratio scales included in the past time intervals; and selecting one of all the time points included in the current time interval as an optimal reference point based on the miss rate or a hit rate and the average value of the past change ratio scales corresponding to the each time unit.

In an embodiment of the disclosure, the step of selecting one of all the time points included in the current time interval as the optimal reference point based on the miss rate and the average value of the past change ratio scales corresponding to each time unit includes drawing a first curve with the time points of the current time interval as a horizontal axis and the miss rate as a vertical axis; drawing a second curve with the past time points as a horizontal axis and the average value of the past change ratio scales corresponding to the each past time point as a vertical axis; superimposing the first curve and the second curve in time order to find an intersection point of the first curve and the second curve; in response to a number of obtained intersection points being greater than or equal to 2, filtering out intersection points with the miss rate greater than a first threshold among the obtained intersection points; in response to a number of remaining intersection points after filtering via the first threshold being greater than or equal to 2, filtering out intersection points with time greater than a second threshold; and using a remaining intersection point after filtering via the second threshold as the optimal reference point.

In an embodiment of the disclosure, in response to the change ratio scale being less than or equal to the average value of the past change ratio scales, the predictive performance information indicating stable prediction is provided on the model operation interface; and in response to the change ratio scale being greater than the average value of the past change ratio scales, the predictive performance information indicating unstable prediction is provided on the model operation interface.

The electronic apparatus for predictive value decision of the disclosure includes a storage device, including historical shipment data and a model operation interface; and a processor, coupled to the storage device and configured to implement the method for predictive value decision.

The non-transitory computer-readable recording medium of the disclosure is used to store a program code. When the program code is executed by a processor, the processor executes the following steps. A shipment predictive value at a target time point is calculated based on historical shipment data. A change ratio scale corresponding to the target time point is calculated based on the shipment predictive value corresponding to the target time point and multiple previous shipment predictive values at multiple time points before the target time point. An average value of the past change ratio scales corresponding to the target time point is calculated based on a historical change ratio scale. Predictive performance information is provided based on the average value of the past change ratio scales and the change ratio scale corresponding to the target time point.

Based on the above, the disclosure correspondingly calculates the shipment predictive value at the target time point through the operation received by the model operation interface, and further provides the predictive performance information for personnel to check the stability of the currently obtained shipment predictive value, so that the personnel have more time to adjust relevant progress of production and shipment to reduce unnecessary cost resources and improve the efficiency of the management mode.

### BRIEF DESCRIPTION OF THE DRAWINGS

FIG. 1 is a block diagram of an electronic apparatus for predictive value decision according to an embodiment of the disclosure.

FIG. 2 is a flowchart of a method for predictive value decision according to an embodiment of the disclosure.

FIG. 3 is a schematic diagram of comparison between a first curve and a second curve according to an embodiment of the disclosure.

FIG. 4 is a schematic diagram of a model operation interface according to an embodiment of the disclosure.

FIG. 5 is a schematic diagram of a comparison result according to an embodiment of the disclosure.

### DETAILED DESCRIPTION OF DISCLOSED EMBODIMENTS

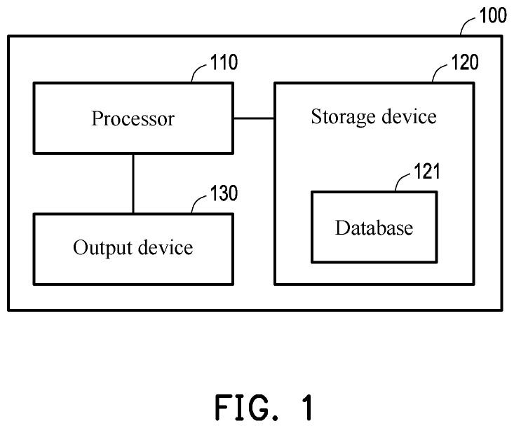

FIG. 1 is a block diagram of an electronic apparatus for predictive value decision according to an embodiment of the disclosure. Please refer to FIG. 1. An electronic apparatus 100 includes a processor 110, a storage device 120, and an output device 130. The processor 110 is coupled to the storage device 120 and the output device 130.

The processor 110 is, for example, a central processing unit (CPU), a physical processing unit (PPU), a programmable microprocessor, an embedded control chip, a digital signal processor (DSP), an application specific integrated circuits (ASIC), or other similar apparatuses.

The storage device 120 is, for example, any type of fixed or removable random access 10 memory (RAM), read only memory (ROM), flash memory, hard drive, other similar apparatuses, or a combination of these apparatuses. The storage device 120 includes one or more program code fragments. The program code fragments are executed by the processor 110 after being installed to obtain a predictive model for predictive value decision. The storage device 120 further includes a database 121 for storing historical shipment data.

The output device 130 is, for example, a display, a printer, etc., for outputting a final result. For example, the output device 130 displays a model operation interface, and outputs at least one of a shipment predictive value, a change ratio scale, a predictive shipment range, and an optimal reference point. The electronic apparatus 100 may be applied to an artificial intelligence (AI) system, which can not only grasp the facts that happened in the past, but also further effectively predict the future.

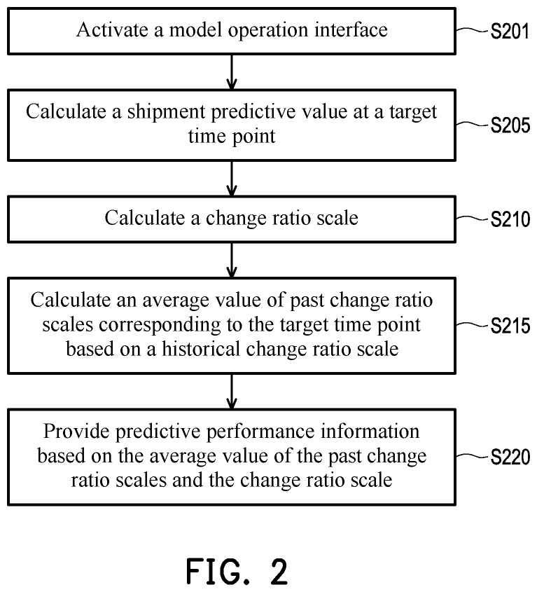

FIG. 2 is a flowchart of a method for predictive value decision according to an embodiment of the disclosure. Please refer to FIG. 1 and FIG. 2. In Step S201, the processor 110 activates the model operation interface. Next, in response to receiving an operation through the model operation interface, Steps S205 to S220 below are executed. For example, the electronic apparatus 100 may be used in a warehouse system. In an embodiment, an application (APP) of the warehouse system is installed in the storage device 120 in advance, and the APP provides the model operation interface. After the APP is enabled, the model operation interface is automatically activated to perform a series of predictive processing.

In Step S205, the processor 110 calculates the shipment predictive value at a target time point. Here, the shipment predictive value may be calculated using a weight estimation method, a ratio estimation method, or a moving scale method. Alternatively, the shipment predictive value may be calculated by combining the ratio estimation method and the moving scale method. For example, the ratio estimation method is used before the 12th (including the 12th) of each month, and the moving scale method is used after the 12th (excluding the 12th). Alternatively, the shipment predictive value may be calculated by combining the weight estimation method and the ratio estimation method. For example, the weight estimation method is used from the 1st to the 10th of each month, and the ratio estimation method is used after the 10th (excluding the 10th).

The concept of the weight estimation method is to use an actual cumulative shipment volume of the current month up to now (the target time point) divided by an average cumulative percentage predictive value as the shipment predictive value at the end of the current month. The average cumulative percentage predictive value is a linear regression model, and the parameters used include the date of the day and a label of each product. The average cumulative percentage predictive value is a shipment proportion obtained using the historical shipment data. Simply put, the proportion of the historical shipment data (product label and daily actual cumulative shipment volume) of the product are predicted using the linear regression model. For example, assuming that the actual cumulative shipment volume on 10/8 is 100 pieces, it can be known from the historical shipment data and linear regression that the actual cumulative shipment volume on the 8th of each month will reach 50% (shipment proportion) of the shipment volume at the end of the month. Accordingly, the shipment predictive value at the end of the current month predicted by the weight estimation method on 10/8 is 100/0.5.

The ratio estimation method is a scaling concept. For example, assuming that the current time interval is one month, the ratio estimation method is to estimate the shipment predictive value at the target time point (the total shipment volume at the end of the month) according to the actual cumulative shipment volume of the current month. The processor 110 may estimate the shipment predictive value at the end of the current month by taking the actual cumulative shipment volume of T past time points included in the current month up to before the target time point, that is,

Shipment predictive value=(Actual cumulative shipment volume÷T)×D,
where D is the total number of time points within the current time interval (for example, the total number of days of the current month).

Assuming that the target time point is 11/13, the shipment predictive value at the end of the current month is estimated by taking the actual cumulative shipment volume from 11/1 to 11/12 being 467,731. The ratio estimation method scales using the actual cumulative shipment volume of the current month up to 11/12, calculates the average shipments on each day, and then expands. For example, the actual cumulative shipment volume of 12 days expanded to 30 days is

$$\frac{467 , 731}{12} \times 30.$$

By analogy, the shipment predictive value corresponding to 11/13 to 11/30 may be obtained, as shown in Table 1.

TABLE 1

| | Shipment predictive value |
|---|---|
| Time point | (based on ratio estimation method) |
| 11/13 | [(Actual cumulative shipment volume |
| | of 11/1 to 11/12)/12] × 30 |
| 11/14 | [(Actual cumulative shipment volume |
| | of 11/1 to 11/13)/13] × 30 |
| . . . | . . . |
| 11/30 | [(Actual cumulative shipment volume |
| | of 11/1 to 11/29)/29] × 30 |

The moving scale method is a variation of the ratio estimation method, which not only uses the historical shipment data of the past time interval as a reference, but also uses the actual cumulative shipment volume of the current time interval as a reference. The processor 110 takes a first actual cumulative shipment volume AcuSₚₐₛₜ(m1) of m1 past time points included in the past time interval from the historical shipment data. Next, a second actual cumulative shipment volume AcuS_{cur}(m2) of m2 time points included in the current time interval up to before the target time point is taken from the historical shipment data. After that, based on the first actual cumulative shipment volume AcuSₚₐₛₜ(m1) and the second actual cumulative shipment volume AcuS_{cur}(m2), a shipment predictive value P at the target time point is calculated. Here, the shipment predictive value at the target time point P=[(AcuSₚₐₛₜ(m1)+AcuS_{cur}(m2))÷(m1+m2)]×(m1+D)−AcuSₚₐₛₜ(m1).

For example, the calculation of the shipment predictive value of November, where m1=20 and m2=12, is taken as an example for illustration. That is, the historical shipment data for the last 20 days of October (10/12 to 10/31) and the shipped shipment data for the first 12 days of November are taken as a reference. Assuming that the actual cumulative shipment volume from 10/1 to 10/12 is 372,220, and the actual cumulative shipment volume from 10/1 to 10/31 is 1,322,045, a first actual cumulative shipment volume AcuSast(20) from 10/12 to 10/31 is 949,825 (=1,322,045-372,220). Also, it is assumed that a second actual cumulative shipment volume AcuS_{cur}(12) from 11/1 to 11/12 is 467,731. A monthly total shipment predictive value on 11/13 is calculated based on the actual cumulative shipment volume AcuS_{cur}(20) from 10/12 to 10/31 and the actual cumulative shipment volume AcuS_{cur}(12) from 11/1 to 11/12, a monthly total shipment predictive value on 11/14 is calculated based on the actual cumulative shipment volume AcuSast(20) from 10/12 to 10/31 and the actual cumulative shipment volume AcuS_{cur}(13) from 11/1 to 11/13, and so on. The results shown in Table 2 are obtained.

TABLE 2

| | Shipment predictive value |
|---|---|
| Time point | (based on moving scale method) |
| 11/13 | [(AcuSₚₐₛₜ(20) + AcuS_{cur}(12)) ÷ |
| | (20 + 12)] × (20 + 30) − AcuSₚₐₛₜ(20) |
| 11/14 | [(AcuSₚₐₛₜ(20) + AcuS_{cur}(13)) ÷ |
| | (20 + 13)] × (20 + 30) − AcuSₚₐₛₜ(20) |
| . . . | . . . |
| 11/30 | [(AcuSₚₐₛₜ(20) + AcuS_{cur}(29)) ÷ |
| | (20 + 29)] × (20 + 30) − AcuSₚₐₛₜ(20) |

In other embodiments, the time points within the current time interval may be divided into earlier and later parts, the ratio estimation method is used to calculate the shipment predictive value for each time point of the earlier part (for example, each day before the 12th (including the 12th) of that month), and the moving scale method is used to calculate the shipment predictive value for each time point of the later part (for example, each day after the 12th (excluding the 12th) of that month).

Next, in Step S210, the change ratio scale is calculated. Specifically, the processor 110 calculates the change ratio scale corresponding to the target time point using the shipment predictive value corresponding to the target time point and multiple previous shipment predictive values at multiple time points before the target time point. In an embodiment, the processor 110 first calculates a weighted average value at the target time point, then calculates a weighted standard deviation at the target time point, and then calculates the change ratio scale.

In an embodiment, the processor 110 calculates the weighted average value at the target 15 time point based on a weight value, the shipment predictive value at the target time point, and a weighted average value at a time point before the target time point. The calculation formula of the weight value is as follows: α=2+(w+1), where α is the weight value. Assuming w=7, then α=2+(7+1)=0.25. Next, the weighted average value at each time point is calculated using the weight value.

For convenience of description, the unit of the current time interval and the past time interval is set to “month”, and the time unit of the time point is set to “day” for illustration. Here, it is assumed that w=7, which means that a time moving segment is 7 days, and the corresponding weighted average value and weighted standard deviation may be obtained every 7 days. Here, w=7 is only for illustration and is not limited thereto. Since the time moving segment is 7 days, the change ratio scale is not calculated for the first 7 days (that is, day 1 to day 7 of the current time interval). The target time point may be one of day 8 to the last day within the current time interval. Since the weighted average value cannot be calculated for day 1 to day 7, a simple moving average (SMA) from day 1 to day 7 is taken as the weighted average value on day 7 to serve as a reference basis for day 8. That is, the weighted average value on day 7 is the average value (the SMA) of the monthly total shipment predictive values from day 1 to day 7. The following is illustrated in conjunction with Table 3 and Table 4. The SMA from day 1 to day 7 is (5+15+25+30+34+38+42)+7=27, so “27” is set as the weighted average value on day 7.

The calculation formula of the weighted average value from day 8 to day 30 is:

wAvg(i)=α(P(i)−wAvg(i−1))+wAvg(i−1);
where wAvg(i) is the weighted average value on the ith day, wAvg(i−1) is the weighted average value on the (i−1)th day, α is the weight value, and P(i) is the shipment predictive value accumulated until the end of the month of the current month calculated on the ith day, where i=8, 9, . . . , 30.

After that, the weighted standard deviation from day 8 to day 30 is respectively calculated based on the weighted average value from day 8 to day 30. The calculation formula of the weighted standard deviation is:

$$wSD ( i ) = \sqrt{\begin{matrix}{( 1 - α )}^{w} \times {( wSD ( i - w ) )}^{2} + α {\sum }_{w = 1}^{w = 7} {( 1 - α )}^{w} \times \\ {( P ( i - w + 1 ) - wAvg ( i - w ) )}^{2}\end{matrix}} .$$

Specifically,
the weighted standard deviation on day

$$8 = \sqrt{\begin{matrix}{( 1 - 0.25 )}^{7} \times {0}^{2} + 0.25 ( {( 1 - 0.25 )}^{1} \times {( 44 - 27 )}^{2} + \\ 0 + 0 + 0 + 0 + 0 + 0 )\end{matrix}} = 7.36$$

the weighted standard deviation on day

$$9 = \sqrt{\begin{matrix}{( 1 - 0.25 )}^{7} \times {0}^{2} + 0.25 ( {( 1 - 0.25 )}^{1} \times {( 46 - 31.25 )}^{2} + \\ {( 1 - 0.25 )}^{2} \times {( 44 - 27 )}^{2} + 0 + 0 + 0 + 0 + 0 )\end{matrix}} = 9.02$$

the weighted standard deviation on day

$$10 = \sqrt{\begin{matrix}{( 1 - 0.25 )}^{7} \times {0}^{2} + 0.25 ( {( 1 - 0.25 )}^{1} \times {( 47 - 34.94 )}^{2} + {( 1 - 0.25 )}^{2} \times \\ {( 46 - 31.25 )}^{2} + {( 1 - 0.25 )}^{3} \times {( 44 - 27 )}^{2} + 0 + 0 + 0 + 0 )\end{matrix}} = 8.74$$

and so on, and the weighted standard deviation on each day from day 11 to day 30 is calculated.

Then, based on the weighted average value corresponding to each day from day 8 to day 30 and the shipment predictive value, the change ratio scale on each day from day 8 to day 30 is calculated. The calculation formula of the change ratio scale is as follows: change ratio scale=(weighted standard deviation×specified magnification)÷shipment predictive value, where the specified magnification ≥1. For example, assuming that the specified magnification=1, the change ratio scale on day 8=7.36÷44=16.7%.

TABLE 3

| | Time point (day) | | | | | | |
|---|---|---|---|---|---|---|---|
| | 1 | 2 | 3 | 4 | 5 | 6 | 7 |
| Shipment predictive value | 5 | 15 | 25 | 30 | 34 | 38 | 42 |
| Average value of first 7 days | — | — | — | — | — | — | 27 |

TABLE 4

| Time point (day) | 7 | 8 | 9 | 10 | 11~30 |
|---|---|---|---|---|---|
| Shipment predictive | 42 | 44 | 46 | 47 | . . . |
| value | | | | | |
| Weight value | — | 0.25 | 0.25 | 0.25 | . . . |
| Weighted average | SMA = 27 | 31.25 | 34.94 | 37.96 | . . . |
| value | | | | | |
| Weighted standard | — | 7.36 | 9.02 | 8.74 | . . . |
| deviation | | | | | |
| Change ratio scale | — | 16.7% | 19.6% | 18.6% | . . . |

In the above embodiment, only the values of the current month (only up to the 30th) are used to calculate the change ratio size of the current month, so the 1st to 7th of the next month will not use the values of the last 7 days at the end of the previous month. In other embodiments, the values of the last 7 days at the end of the previous month may be used for the first 7 days of the next month to calculate the change ratio size. For example, by continuously calculating 7/1 to 8/31 for illustration, the weighted average value cannot be calculated from 7/1 to 7/7 (the first 7 days), but the values from 7/25 to 7/31 may be used as reference when the shipment predictive value at the end of August is predicted on 8/1. Therefore, the change ratio scale only cannot be calculated for the first 7 days (7/1 to 7/7) from 7/1 to 8/31, and the change ratio scale can be calculated for all subsequent dates.

In addition, in Step S215, the processor 110 calculates an average value of past change ratio scales corresponding to the target time point based on historical change ratio scales. Next, in Step S220, predictive performance information is provided based on the average value of the past change ratio scales and the change ratio scale corresponding to the target time point. In response to the change ratio scale being less than or equal to the average value of the past change ratio scales, the predictive performance information indicating stable prediction is provided on the model operation interface. In response to the change ratio scale being greater than the average value of the past change ratio scales, the predictive performance information indicating unstable prediction is provided on the model operation interface.

For example, assuming that the current time interval is August 2021, May 2020 to July 2021 are taken as 15 past time intervals, and the target time point is day 18 of each month, the predicted change ratio scale obtained on the day of Aug. 18, 2021 is compared with the average value of the past change ratio scales for the past 15 months corresponding to day 18. That is, the historical change ratio scales on day 18 of 15 months are calculated using the shipment predictive value of the past 15 months (the calculation manner thereof is the same as Step S210), and the average of the 15 historical change ratio scales corresponding to day 18 of the past 15 months is then calculated, so as to obtain the average value of the past change ratio scales corresponding to day 18.

In an embodiment, the stability of the shipment predictive value at the target time point may be judged based on the change ratio scale and the average value of the past change ratio scales. For example, when the change ratio scale is less than the average value of the past change ratio scales, the shipment predictive value is judged to be more stable than before.

In addition, in an embodiment, a comparison threshold may also be set to judge the stability of the shipment predictive value at the target time point. For example, after calculating the change ratio scale on each day, whether the change ratio scale is less than the comparison threshold is judged. In response to the change ratio scale being less than the comparison threshold, the shipment predictive value is judged to be stable, indicating that the accuracy of the shipment predictive value is high (that is, the shipment predictive value is closer to an actual shipment value). In an embodiment, in response to the change ratio scale being less than the comparison threshold, the processor 110 uses the corresponding time point as the optimal reference point. In response to the change ratio scale not being less than the comparison threshold, the shipment predictive value is judged to be unstable, indicating that the accuracy of the shipment predictive value is not high.

In addition, a fixed ratio scale may be further determined, so as to calculate the predictive shipment range on each day. The fixed ratio scale may be set to 5%, 10%, 15%, 20%, etc. The same fixed ratio scale is used each day to calculate the predictive shipment range. For example, the shipment predictive value at the target time point plus the fixed ratio scale is used as the upper limit value of the predictive shipment range, and the shipment predictive value minus the fixed ratio scale is used as the lower limit value of the predictive shipment range. Taking day 8 in Table 4 as an example, assuming that the fixed ratio scale is 15%, the predictive shipment range on day 8 is 44−(44×15%) to 44+(44×15%).

In addition, after obtaining the predictive shipment range on each day within the current time interval, the optimal reference point may be further selected based on actual shipment data of the past time interval and the predictive shipment range on each day within the current time interval. Here, for the convenience of description, the unit of the current time interval and the past time interval is set to “month”, and the unit of the time point is set to “day” for illustration. The actual shipment data of multiple past months is also recorded in the historical shipment data.

Specifically, the processor 110 takes the actual shipment data of the past months from the historical shipment data, and calculates a miss rate on each day based on the shipment data on each day within the past months and the predictive shipment range on each day within the current month. For example, the actual shipment data of the past 15 months (assuming that the number of days included in the 15 months are the same and are all 30 days) is taken for illustration, and day 15 is used for illustration, assuming that there are a total of 5 pieces of the actual shipment data falling within the predictive shipment range on day 15 of the current month for the past 15 months, and the other 10 pieces are not within the predictive shipment range on day 15 of the current month, the miss rate on day 15 is 10/15, and a hit rate is 5/15. In an embodiment, when the miss rate on day 15 of the current month is lower than a predetermined rate or the hit rate is higher than a predetermined rate, the processor 110 recommends day 15 of the current month as the optimal reference point.

Moreover, based on the shipment predictive value of the past 15 months, the change ratio scale on each day within the 15 months (hereinafter referred to as “historical change ratio scale”) is calculated, the weighted average value, the weighted standard deviation, and the change ratio scale from day 8 to day 30 of the past 15 months are calculated, and reference may be made to the description of Step S210 for the calculation processes. After calculating the historical change ratio scale on each day within the past 15 months, based on all the historical change ratio scales included in the past 15 months, the average value of the past change ratio scales corresponding to each time unit is calculated. For example, taking day 15 as an example, the average value of the past change ratio scales corresponding to day 15 may be obtained by adding the past change ratio scales on day 15 in the past 15 months and taking the average. In an embodiment, If the average value of the past change ratio scales corresponding to day 15 is greater than a predetermined value, the processor 110 recommends day 15 of each month as the optimal reference point.

Then, based on the miss rate, the hit rate, and the average value of the past change ratio scales corresponding to each time unit, one of the days included in the current month is selected as the optimal reference point.

For example, a first curve is drawn with the past time point as the horizontal axis and the miss rate (or the hit rate) as the vertical axis. In addition, a second curve is drawn with the past time point as the horizontal axis and the average value of the past change ratio scales as the vertical axis. After that, the first curve and the second curve are superimposed in time order to find an intersection point of the first curve and the second curve. In response to the number of the obtained intersection points being greater than or equal to 2, intersection points with the miss rate greater than a first threshold are filtered out among the obtained intersection points. This is because the lower the miss rate, the higher the accuracy of the shipment predictive value. In response to the number of the remaining intersection points after filtering via the first threshold being greater than or equal to 2, intersection points with time greater than a second threshold are filtered out. This is because the later the time, the more the time for shipment preparation is shortened, so the second threshold is set to limit the time. Finally, the remaining intersection point after filtering via the second threshold is used as the optimal reference point.

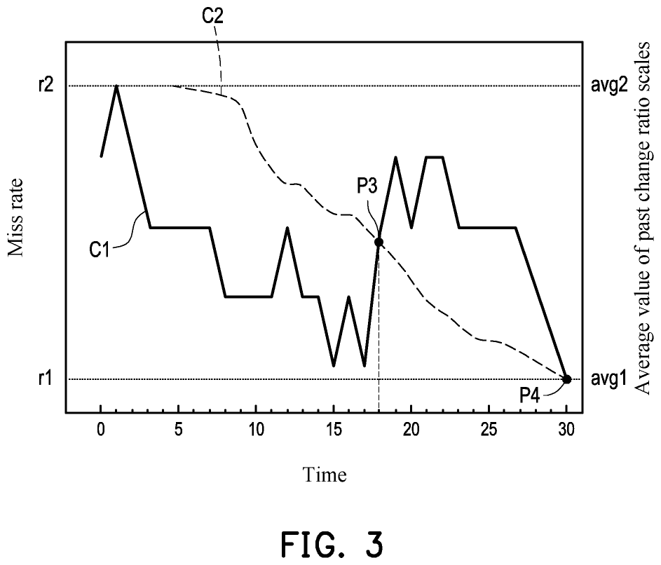

FIG. 3 is a schematic diagram of comparison between a first curve and a second curve according to an embodiment of the disclosure. Please refer to FIG. 3. A first curve C1 is obtained with the time points of the past time interval (for example, dates 1st, 2nd, . . . , 30th) as the horizontal axis and the miss rate as the vertical axis. A second curve C2 is obtained with the time points of the past time interval (for example, dates 1st, 2nd, . . . , 30th) as the horizontal axis and the average value of the past change ratio scales as the vertical axis. In the embodiment, the first curve C1 and the second curve C2 share the X-axis (the horizontal axis), the left Y-axis (the vertical axis) corresponds to the miss rate, and the right Y-axis corresponds to the average value of the past change ratio scales. The equivalent correspondence of the Y-axis is performed by fixing the highest point and the lowest point. For example, assuming that the miss rate of the first curve C1 is between r1 and r2, and the average value of the past change ratio scales of the second curve C2 is between avg1 and avg2, r1 corresponds to avg1, and r2 corresponds to avg2.

The first curve C1 and the second curve C2 have two intersection points P3 and P4. A first filtering is first performed using the miss rate, and a second filtering is then performed using time. Since the lower the miss rate, the better, the intersection points with the miss rate greater than the first threshold are filtered out. For example, the first threshold is set to (r2−r1)/3, the intersection points P3 and P4 are both retained in the first filtering. Next, the intersection points with time greater than the second threshold are filtered out. For example, the second threshold is set to day 20, only the intersection point P3 is retained in the second filtering. Therefore, the intersection point P3 (day 18) is taken as the optimal reference point. That is, the shipment predictive values after day 18 are all credible.

In addition, in other embodiments, the first filtering may be performed with time, and the second filtering may be performed with the miss rate. For example, the second threshold is set to day 20, only the intersection point P3 is retained in the first filtering, and the second filtering with the miss rate does not need to be performed subsequently.

For example, when the time moving segment and the specified magnification of the weighted standard deviation are respectively set to 7 days and 3, during the period from May 2020 to August 2021, there are only 2 pieces of the actual shipment data not falling within the predictive shipment range on that day of the month on the 18th and the 30th, indicating that the two days are dates that are relatively stable and have a high hit rate. If the fixed ratio scale is set to 15%, it can be assumed that the acceptable change ratio scale cannot be greater than 15%, so the matching date is after the 17th. Comprehensively considering the hit rate, a risk level, and immediacy, the shipment predictive value on day 18 is the optimal solution (the optimal reference point).

Determining the fixed ratio scale to find the acceptable hit rate, and simulating various time moving segments and the specified magnification of the weighted standard deviation to quantify the risk level of the daily shipment predictive value can not only verify that the moving scale method for monthly overall performance trend has a higher accuracy, but also additionally provide the extent to which the daily shipment predictive value can be trusted, which improves personnel trust and usability of the moving scale method. The following is illustrated with Table 5 and Table 6.

Table 5 shows that after setting the fixed ratio scale, based on the moving scale method, personnel experience estimation, and using the moving scale method as a secondary estimate value of personnel experience (for example, prediction is performed with personnel experience before the 18th, and using the predictive model after the 18th), and the corresponding hit rate is presented in Table 5. Table 6 shows that after setting the fixed hit rate, based on the moving scale method, the personnel experience estimation, and using the moving scale method as the secondary estimation value of personnel experience, the corresponding fixed ratio scale is presented in Table 6.

TABLE 5

| Fixed ratio | Hit rate obtained based on | Hit rate obtained by | Personnel experience combined |
|---|---|---|---|
| scale | moving scale method | personnel experience | with hit rate on day 18 |
| 5% | 48% | 19% | 21% |
| 10% | 72% | 25% | 41% |
| 15% | 90% | 65% | 80% |

The fourth column in Table 5 is used to indicate that if personnel experience prediction is used before the 18th, and the predictive model is only used for prediction after the 18th, the hit rate of the shipment volume can still be improved and enhanced. In addition, due to the use of personnel experience, there are sometimes settings to modify the shipment predictive value twice around the 18th. Therefore, if a predictive result on day 18 obtained using the predictive model is used instead of pure personnel experience, the hit rate of the shipment volume can be improved and enhanced. The hit rate may be calculated as long as the shipment predictive values predicted by personnel experience are changed to be predicted by the predictive model after day 18, and the ratio of the number of times of hitting the actual value in the corresponding interval to the total number of times is then looked at.

TABLE 6

| | Fixed ratio scale based | Fixed ratio scale obtained | Personnel experience combined |
|---|---|---|---|
| Hit rate | on moving scale method | by personnel experience | with fixed ratio scale on day 18 |
| 80% | 12% | 26% | 15% |
| 90% | 15% | 29% | 18% |
| 95% | 23% | 35% | 26% |

It can be seen from Table 5 and Table 6 that the higher the fixed ratio scale, the higher the hit rate; and it is further verified that the moving scale method has a higher accuracy for the overall performance trend. Also, the acceptable hit rate may be further found through the fixed ratio scale.

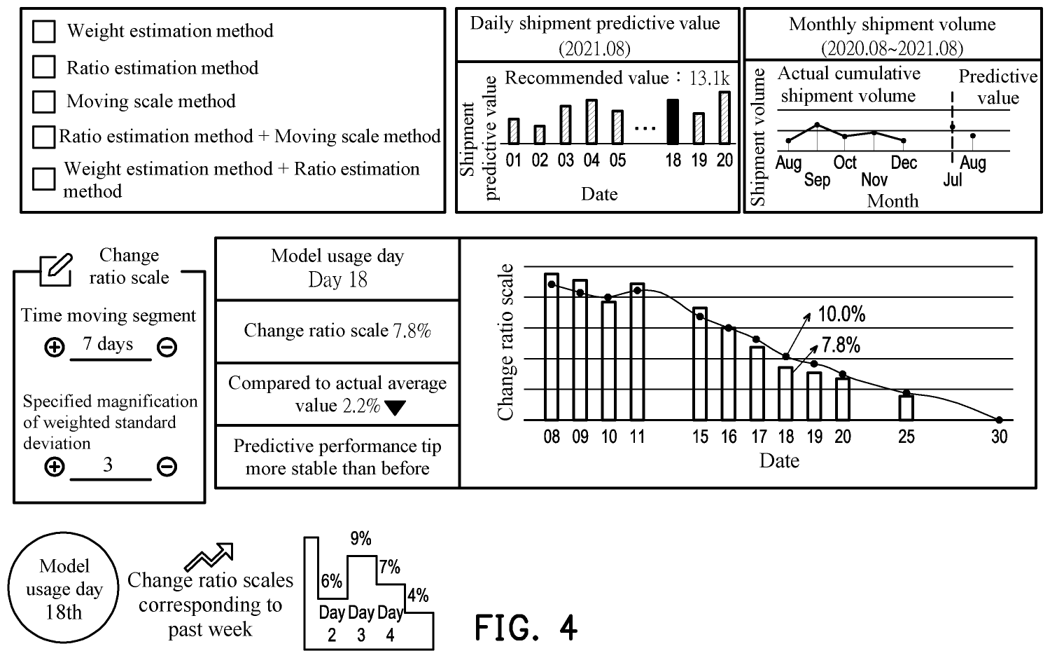

FIG. 4 is a schematic diagram of a model operation interface according to an embodiment of the disclosure. In the model operation interface shown in FIG. 4, a user may select one of multiple calculation methods to calculate the shipment predictive value. Here, 5 calculation methods are provided, that is, the weight estimation method, the ratio estimation method, the moving scale method, the ratio estimation method+the moving scale method, and the weight estimation method+the ratio estimation method. After selection, the shipment predictive value on each day in the current time interval (August 2021) is displayed as a histogram on the model operation interface. In addition, a graph of the actual shipment volume respectively corresponding to multiple past time intervals (August 2020 to July 2021) and the obtained recommended shipment predictive value (for example, 13.1 k) in the current time interval may also be simultaneously presented on the model operation interface.

The model operation interface further provides parameter adjustment related to the change ratio scale. For example, the user may set the time moving segment and the specified magnification of the weighted standard deviation on the model operation interface. After selecting the time moving segment and the specified magnification of the weighted standard deviation, a comparison chart is further displayed on the model operation interface, that is, the change ratio scale on each day of the current month is presented as a straight bar, and the average value of the past change ratio scales corresponding to each day of the past multiple months is presented as a curve.

In the embodiment, the obtained model usage day (the optimal reference point) is day 18. In terms of day 18, the change ratio scale on Aug. 18, 2021 is 7.8%, and the average value of the past change ratio scales on every 18th of the past 15 months is 10.0%. “Compared to actual average value” refers to the difference between the change ratio scale on Aug. 18, 2021 and the average value of the past change ratio scales on the 18th, which is a decline by 2.2% in the embodiment. Also, the predictive performance information may be further determined based on “Compared to actual average value”. For example, if “Compared to actual average value” is a decline, “Predictive performance tip more stable than before” is displayed. In addition, in the case where “Compared to actual average value” is a rise, “Predictive performance tip unstable” is set to be displayed. In addition, the change ratio scale corresponding to only the past week may be further displayed (the bottom of FIG. 4). For example, the current date is Aug. 18, 2021, the change ratio scale from August 12 to Aug. 18, 2021 is displayed as a histogram.

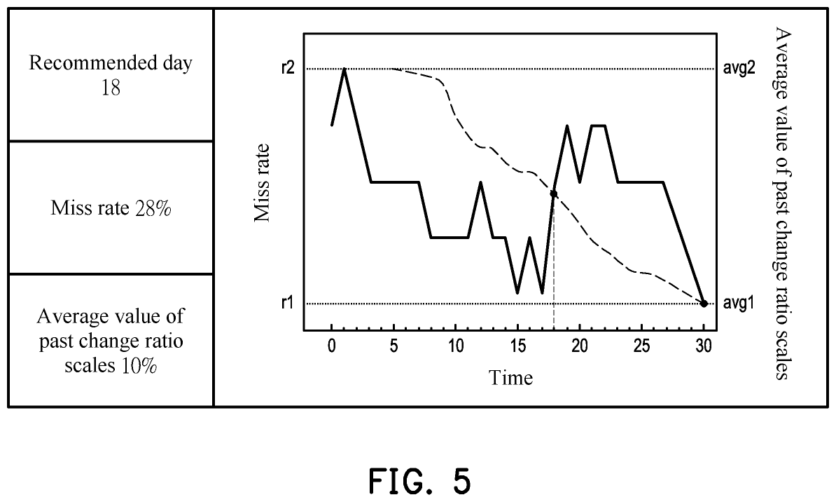

In addition, the model operation interface may additionally provide the comparison result shown in FIG. 5. FIG. 5 is a schematic diagram of a comparison result according to an embodiment of the disclosure. For example, the display screen shown in FIG. 5 may be directly superimposed on the display screen shown in FIG. 4. Please refer to FIG. 5. The left column shows that the recommended day (the optimal reference point) of that month is day 18, the miss rate on day 18 is 28%, and the average value of the past change ratio scales is 10%.

In summary, the disclosure is different from relying only on personnel experience of the business unit. Using the historical data of the actual shipment volume to establish a model can not only obtain the daily predictive shipment range, but also know the shipment predictive value at the end of the month on a daily basis, so that the shipment predictive value has the property of approaching the monthly shipment actual value day by day. Moreover, it is possible to decide which day to use as the optimal reference point, which provides a quantitative indicator with scientific logic, so that the predictive model not only has high accuracy, but also has a high level of trust.

Accordingly, the optimal reference point may be obtained before the last time point of the current time interval, so that the personnel have more time to adjust relevant progress of production and shipment to reduce unnecessary cost resources and improve the efficiency of the management mode. In addition, it is possible to reduce the risk of insufficient shipments due to underestimated shipments or the issue of inventory accumulation due to overestimated shipments.

For the personnel predicting information, finding the optimal solution (the optimal reference point) can help the creator of the predictive model to continuously track and monitor the performance of the predictive model. For example, assuming that the optimal solution obtained for the first time is day 18, during model training, it is found that the predictive model starts to shift from the 18th to earlier dates after iterating, which means that the predictive model is getting more and more accurate. However, if the predictive model shifts from the 18th to later dates, it means that the predictive model starts to be inaccurate, and the developer needs to manually optimize the predictive model. Therefore, the optimal solution may also be used as one of the monitoring methods for the performance of the predictive model.

What is claimed is:

1. A method for predictive value decision, executed by a processor, the method comprising:
activating a model operation interface, and in response to receiving an operation through the model operation interface, executing following steps:
calculating a shipment predictive value at a target time point based on historical shipment data;
calculating a change ratio scale corresponding to the target time point using the shipment predictive value corresponding to the target time point and a plurality of previous shipment predictive values at a plurality of time points before the target time point;
calculating an average value of past change ratio scales corresponding to the target time point based on historical change ratio scales; and
providing predictive performance information based on the average value of the past change ratio scales and the change ratio scale corresponding to the target time point.

2. The method for predictive value decision according to claim 1, wherein the step of calculating the shipment predictive value at the target time point based on the historical shipment data comprises:
taking an actual cumulative shipment volume at T past time points comprised within a current time interval up to the target time point from the historical shipment data to calculate the shipment predictive value at the target time point, wherein
the shipment predictive value at the target time point=(the actual cumulative shipment÷T)×D,
where D is a total number of time points within the current time interval.

3. The method for predictive value decision according to claim 1, wherein the step of calculating the shipment predictive value at the target time point based on the historical shipment data comprises:
taking a first actual cumulative shipment volume at m1 past time points comprised within a past time interval from the historical shipment data;
taking a second actual cumulative shipment volume at m2 time points comprised within a current time interval up to the target time point from the historical shipment data; and
calculating the shipment predictive value at the target time point based on the first actual cumulative shipment volume and the second actual cumulative shipment volume, wherein
the shipment predictive value at the target time point=[(the first actual cumulative shipment volume+the second actual cumulative shipment volume)÷(m1+m2)]×(m1+D)−the first actual cumulative shipment volume,
where D is a total number of time points within the current time interval.

4. The method for predictive value decision according to claim 1, wherein the step of calculating the shipment predictive value at the target time point based on the historical shipment data comprises:
taking an actual cumulative shipment volume at T past time points comprised within a current time interval up to the target time point from the historical shipment data;
estimating a shipment proportion based on the historical shipment data; and
calculating the shipment predictive value at the target time point based on the actual cumulative shipment volume and the shipment proportion.

5. The method for predictive value decision according to claim 1, wherein the step of calculating the change ratio scale corresponding to the target time point comprises:
calculating a weighted average value at the target time point based on a weight value, the shipment predictive value at the target time point, and a weighted average value at a time point before the target time point, wherein the target time point is one of an (n+1)th time point to a last time point within a current time interval, and a weighted average value at an nth time point within the current time interval is an average value of n shipment predictive values from a 1st time point to the nth time point;
calculating a weighted standard deviation at the target time point based on the weight value, and the shipment predictive values and the weighted average values at the target time point and previous time points; and
calculating the change ratio scale based on the weighted average value and the shipment predictive value corresponding to the target time point,
wherein the change ratio scale=(the weighted standard deviation×a specified magnification)÷the shipment predictive value, where the specified magnification≥1.

6. The method for predictive value decision according to claim 1, further comprising:
adding a fixed ratio scale to the shipment predictive value at the target time point as an upper limit value of a predictive shipment range, and subtracting the fixed ratio scale from the shipment predictive value at the target time point as a lower limit value of the predictive shipment range.

7. The method for predictive value decision according to claim 6, further comprising:
calculating a miss rate or a hit rate at each time point of the current time interval based on actual shipment data of a plurality of past time intervals comprised in the historical shipment data and the predictive shipment range at each time point within a current time interval;
calculating a plurality of past change ratio scales at a plurality of past time points comprised in each of the past time intervals based on a shipment predictive value of each of the past time intervals, wherein all time points within the current time interval and all past time points within each of the past time intervals are set based on a time unit;
calculating the average value of the past change ratio scales corresponding to the each time unit based on the past change ratio scales comprised in the past time intervals; and
selecting one of all the time points comprised in the current time interval as an optimal reference point based on the miss rate or the hit rate and the average value of the past change ratio scales corresponding to the each time unit.

8. The method for predictive value decision according to claim 7, wherein the step of selecting one of all the time points comprised in the current time interval as the optimal reference point based on the miss rate and the average value of the past change ratio scales corresponding to the each time unit comprises:
drawing a first curve with the time points of the current time interval as a horizontal axis and the miss rate corresponding to the each time point as a vertical axis;
drawing a second curve with the past time points as a horizontal axis and the average value of the past change ratio scales corresponding to the each past time point as a vertical axis;
superimposing the first curve and the second curve in time order to find an intersection point of the first curve and the second curve;
in response to a number of obtained intersection points being greater than or equal to 2, filtering out intersection points with the miss rate greater than a first threshold among the obtained intersection points;
in response to a number of remaining intersection points after filtering via the first threshold being greater than or equal to 2, filtering out intersection points with time greater than a second threshold; and
using a remaining intersection point after filtering via the second threshold as the optimal reference point.

9. The method for predictive value decision according to claim 1, wherein the step of providing the predictive performance information comprises:
in response to the change ratio scale being less than or equal to the average value of the past change ratio scales, providing the predictive performance information indicating stable prediction on the model operation interface; and
in response to the change ratio scale being greater than the average value of the past change ratio scales, providing the predictive performance information indicating unstable prediction on the model operation interface.

10. An electronic apparatus for predictive value decision, comprising:
a storage device, comprising historical shipment data and a model operation interface; and
a processor, coupled to the storage device and executing:
activating the model operation interface, and in response to receiving an operation through the model operation interface, executing:
calculating a shipment predictive value at a target time point based on the historical shipment data;
calculating a change ratio scale corresponding to the target time point using the shipment predictive value corresponding to the target time point and a plurality of previous shipment predictive values at a plurality of time points before the target time point;
calculating an average value of past change ratio scales corresponding to the target time point based on a historical change ratio scale; and
providing predictive performance information based on the average value of the past change ratio scales and the change ratio scale corresponding to the target time point.

11. The electronic apparatus according to claim 10, wherein the processor executes:
taking an actual cumulative shipment volume at T past time points comprised within a current time interval up to the target time point from the historical shipment data to calculate the shipment predictive value at the target time point, wherein
the shipment predictive value at the target time point=(the actual cumulative shipment÷T)×D,
where D is a total number of time points within the current time interval.

12. The electronic apparatus according to claim 10, wherein the processor executes:
taking a first actual cumulative shipment volume at m1 past time points comprised within a past time interval from the historical shipment data;
taking a second actual cumulative shipment volume at m2 time points comprised within a current time interval up to the target time point from the historical shipment data; and
calculating the shipment predictive value at the target time point based on the first actual cumulative shipment volume and the second actual cumulative shipment volume, wherein
the shipment predictive value at the target time point=[(the first actual cumulative shipment volume+the second actual cumulative shipment volume)÷(m1+m2)]×(m1+D)−the first actual cumulative shipment volume,
where D is a total number of time points within the current time interval.

13. The electronic apparatus according to claim 10, wherein the processor executes:
taking an actual cumulative shipment volume at T past time points comprised within a current time interval up to the target time point from the historical shipment data;
estimating a shipment proportion based on the historical shipment data; and
calculating the shipment predictive value at the target time point based on the actual cumulative shipment volume and the shipment proportion.

14. The electronic apparatus according to claim 10, wherein the processor executes:
calculating a weighted average value at the target time point based on a weight value, the shipment predictive value at the target time point, and a weighted average value at a time point before the target time point, wherein the target time point is one of an (n+1)th time point to a last time point within a current time interval, and a weighted average value at an nth time point within the current time interval is an average value of n shipment predictive values from a 1st time point to the nth time point;
calculating a weighted standard deviation at the target time point based on the weight value, and the shipment predictive values and the weighted average values at the target time point and previous time points; and
calculating the change ratio scale based on the weighted average value and the shipment predictive value corresponding to the target time point,
wherein the change ratio scale=(the weighted standard deviation×a specified magnification)÷the shipment predictive value, where the specified magnification≥1.

15. The electronic apparatus according to claim 10, wherein the processor executes:
adding a fixed ratio scale to the shipment predictive value at the target time point as an upper limit value of a predictive shipment range, and subtracting the fixed ratio scale from the shipment predictive value at the target time point as a lower limit value of the predictive shipment range.

16. The electronic apparatus according to claim 15, wherein the processor executes:
calculating a miss rate or a hit rate at each time point of the current time interval based on actual shipment data of a plurality of past time intervals comprised in the historical shipment data and the predictive shipment range at each time point within a current time interval;
calculating a plurality of past change ratio scales at a plurality of past time points comprised in each of the past time intervals based on a shipment predictive value of each of the past time intervals, wherein all time points within the current time interval and all past time points within each of the past time intervals are set based on a time unit;
calculating the average value of the past change ratio scales corresponding to the each time unit based on the past change ratio scales comprised in the past time intervals; and
selecting one of all the time points comprised in the current time interval as an optimal reference point based on the miss rate or the hit rate and the average value of the past change ratio scales corresponding to the each time unit.

17. The electronic apparatus according to claim 16, wherein the processor executes:
drawing a first curve with the time points of the current time interval as a horizontal axis and the miss rate corresponding to the each time point as a vertical axis;
drawing a second curve with the past time points as a horizontal axis and the average value of the past change ratio scales corresponding to the each past time point as a vertical axis;
superimposing the first curve and the second curve in time order to find an intersection point of the first curve and the second curve;
in response to a number of obtained intersection points being greater than or equal to 2, filtering out intersection points with the miss rate greater than a first threshold among the obtained intersection points; and
in response to a number of remaining intersection points obtained after filtering via the first threshold being greater than or equal to 2, after filtering out intersection points with time greater than a second threshold, using a remaining intersection point as the optimal reference point.

18. The electronic apparatus according to claim 10, wherein the processor executes:
in response to the change ratio scale being less than or equal to the average value of 15 the past change ratio scales, providing the predictive performance information indicating stable prediction on the model operation interface; and
in response to the change ratio scale being greater than the average value of the past change ratio scales, providing the predictive performance information indicating unstable prediction on the model operation interface.

19. A non-transitory computer-readable recording medium for storing a program code, wherein the program code is executed by a processor, the processor executes following steps:
calculating a shipment predictive value at a target time point based on historical shipment data;
calculating a change ratio scale corresponding to the target time point using the shipment predictive value corresponding to the target time point and a plurality of previous shipment predictive values at a plurality of time points before the target time point;
calculating an average value of past change ratio scales corresponding to the target time point based on historical change ratio scales; and
providing predictive performance information based on the average value of the past change ratio scales and the change ratio scale corresponding to the target time point.
